(19) United States
(12) Patent Application Publication
(10) Pub. No.: US 2017/0008332 A1
(43) Pub. Date: Jan. 12, 2017

(54) WRITING DEVICE HAVING A RIBBED STYLUS TIP

(71) Applicant: QUALCOMM Incorporated, San Diego, CA (US)

(72) Inventors: Eric Mattis, San Diego, CA (US); Brandon Blom, San Diego, CA (US)

(21) Appl. No.: 14/792,454

(22) Filed: Jul. 6, 2015

(51) Int. Cl. B43K 29/00; G06F 3/0354; B43K 17/01

(52) U.S. Cl. CPC B43K 29/00; B43K 17/01; G06F 3/03545

(57) ABSTRACT

There is provided a reversible ink-stylus assembly that includes an ink cartridge assembly. The ink cartridge assembly includes an ink cartridge and an ink tip, where the ink tip is attached to a first end of the ink cartridge. The reversible ink-stylus assembly also includes a stylus tip having a plurality of ribs along a longitudinal axis of the reversible ink-stylus assembly. The stylus tip is attached to a second end of the ink cartridge, and the ink cartridge assembly is insertable into a longitudinal cylindrical opening of a writing device.

### TECHNICAL FIELD

Embodiments disclosed herein are generally directed to a writing device having a ribbed stylus tip.

### BACKGROUND

Ultrasound pen designs may use a reversible stylus assembly that allows a user to switch between an ink tip and a stylus tip. This allows the user to write on a tablet with the stylus tip or to write on a notepad using the ink tip. An ultrasound pen may include an assembly having an ink tip and a stylus tip, and a cartridge holder. The cartridge holder is located inside the ultrasound pen and attaches to the cartridge assembly. The cartridge holder captures each tip of the cartridge assembly, either the ink tip or the stylus tip, while the user is using the product. The cartridge holder is designed to retain the cartridge inside the product until the user wants to switch to a different tip by reversing the cartridge assembly.

In some ultrasound pens, to use the ink side, the user inserts the stylus tip of the cartridge assembly into the cartridge holder and waits to hear a click, which indicates to the user that the cartridge assembly is securely attached to the cartridge holder. In this case, the ink tip protrudes from the product and the user may begin writing using the ink tip because she knows that the cartridge assembly is properly seated in the product.

In some ultrasound pens, the stylus tip may have different diameters in the fingernail-groove section (e.g., the front body diameter of the stylus tip may be smaller near the end than the main body diameter). In some ultrasound pens, to use the stylus tip, the user inserts the ink tip of the cartridge assembly into the cartridge holder and should wait to hear two clicks before using the ultrasound pen to write on a tablet. Unfortunately in these ultrasound pen designs, if the user hears only one click, the user may think that the cartridge assembly is properly inserted into the cartridge holder and start to use the stylus tip. This single click could produce a false sense of having the stylus tip properly seated for use in the product and may hinder the product's performance. For example, transmitters may be disposed on the ultrasound pen, which may transmit signals to a pressure sensing device as an indication of the ultrasonic pen's location. If the cartridge assembly is not properly seated in the product, the ultrasonic pen's transmitted location may be inaccurate. Accordingly, the user may experience performance degradation because the cartridge assembly is not properly inserted into the cartridge holder.

Additionally, if not seated properly, the cartridge assembly may fall out of the ultrasound pen. To prevent the cartridge assembly from falling out of the ultrasound pen, the cartridge assembly should be completely seated in the cartridge holder to guarantee that it remains in the product as well as the performance of the force sensor.

### SUMMARY

Accordingly, this creates an inconsistent user experience for the user. It may be desirable to provide an ultrasound pen design that provides the user with a consistent user experience (e.g., a one-click experience for both tips).

Consistent with some embodiments, there is provided a reversible ink-stylus assembly that includes an ink cartridge assembly. The ink cartridge assembly includes an ink cartridge and an ink tip, where the ink tip is attached to a first end of the ink cartridge. The reversible ink-stylus assembly also includes a stylus tip having a plurality of ribs along a longitudinal axis of the reversible ink-stylus assembly. The stylus tip is attached to a second end of the ink cartridge, and the ink cartridge assembly is insertable into a longitudinal cylindrical opening of a writing device.

According to another embodiment, there is provided a writing device that includes a reversible ink-stylus assembly. The reversible ink-stylus assembly includes an ink cartridge assembly that includes an ink cartridge and an ink tip. The ink tip is attached to a first end of the ink cartridge. The reversible ink-stylus assembly also includes a stylus tip having a plurality of ribs along a longitudinal axis of the reversible ink-stylus assembly. The stylus tip is attached to a second end of the ink cartridge. The writing device also includes a cartridge holder located inside the writing device. The cartridge holder attaches to the plurality of ribs of the stylus tip.

### BRIEF DESCRIPTION OF THE DRAWINGS

FIG. 1 is a diagram illustrating a writing device, consistent with some embodiments.

FIG. 2 is a diagram illustrating a reversible ink-stylus assembly, consistent with some embodiments.

FIG. 3 shows a closer view of the stylus tip of the reversible ink-stylus assembly, consistent with some embodiments.

FIG. 4 shows another view of the stylus tip, consistent with some embodiments.

FIG. 5 is a diagram illustrating a stylus tip having a finger-nail groove section, consistent with some embodiments.

FIG. 6 is a diagram illustrating the formation of the plurality of ribs on the fingernail-groove section, consistent with some embodiments.

FIG. 7 is a view of the stylus tip attached to an end of the ink cartridge assembly, consistent with some embodiments.

FIG. 8 shows a section view taken along cross section A-A shown in FIG. 7, consistent with some embodiments.

FIG. 9 shows a top cross section view of the ink cartridge assembly shown in FIG. 7, consistent with some embodiments.

FIG. 10 shows a radial view taken along cross section B-B shown in FIG. 7, consistent with some embodiments.

FIG. 11 shows a closer view of the ink tip having a finger-nail groove section, consistent with some embodiments.

### DETAILED DESCRIPTION

In the following description specific details are set forth describing certain embodiments. It will be apparent, however, to one skilled in the art that the disclosed embodiments may be practiced without some or all of these specific details. The specific embodiments presented are meant to be illustrative, but not limiting. One skilled in the art may realize other material that, although not specifically described herein, is within the scope and spirit of this disclosure.

The accompanying drawings, which form a part of the specification, illustrate embodiments of the disclosure and together with the description, further serve to explain the principles of the embodiments. In the drawings, like reference numbers may indicate identical or functionally similar elements. The drawing in which an element first appears is generally indicated by the left-most digit in the corresponding reference number. However, sometimes these elements may be labeled with differing numbers, such as, for example, in cases where such labeling facilitates a more clear description.

Additionally, the drawings set forth herein are not necessarily drawn to scale, and in some instances proportions may have been exaggerated to more clearly depict certain features. Such labeling and drawing practices do not necessarily implicate an underlying substantive purpose. As stated above, the present specification is intended to be taken as a whole and interpreted in accordance with the principles of the present disclosure as taught herein and understood to one of ordinary skill in the art.

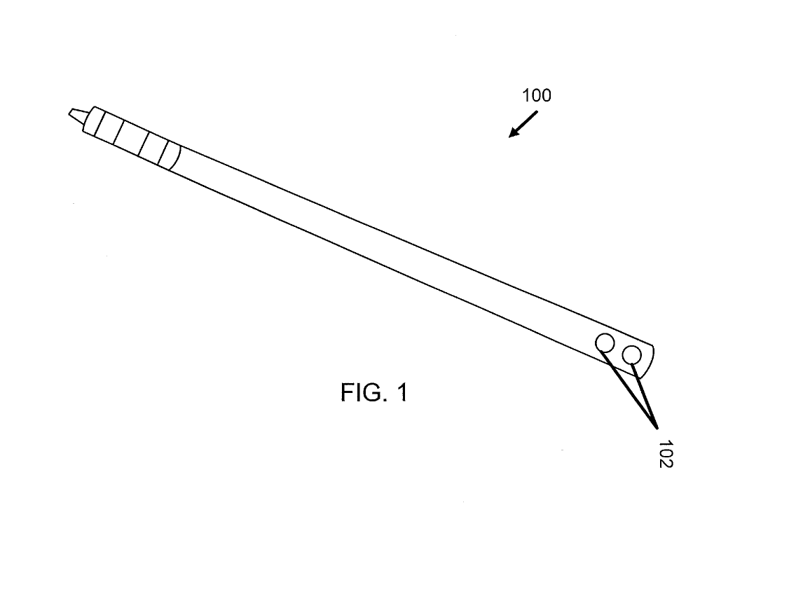

FIG. 1 is a diagram illustrating a writing device 100, consistent with some embodiments. Writing device 100 may be for use on paper and an electronic display device. Writing device 100 may be part of a system for determining a position of the writing device. In an example, one or more transmitters 102 may be disposed on writing device 100 and transmit signals to a sensing device (not shown) that performs an action based on the location of the writing device.

In some embodiments, writing device 100 includes a reversible ink-stylus assembly that attaches to a cartridge holder located inside writing device 100. The reversible ink-stylus assembly may include an ink tip and a stylus tip. The stylus tip may have a plurality of ribs along a longitudinal axis of the reversible ink-stylus assembly. If a user desires to write on paper, the user may insert the reversible ink-stylus assembly tip into the cartridge holder stylus-tip first, such that the ink tip protrudes from an orifice of writing device 100. In an example, if the user hears one “click,” this may indicate to the user that the reversible ink-stylus assembly has been properly inserted into the cartridge holder. Accordingly, the user may commence writing on paper with writing device 100, using the ink tip. It may be desirable to provide the user with a consistent user experience such that the same event (e.g., a single click) causes the user to determine that the reversible ink-stylus assembly has been properly seated into the cartridge holder. In some examples, writing device 100 produces a common event (e.g., a single click) when the stylus tip is inserted into the writing device and also when the ink tip is inserted into the writing device.

If the user desires to write on the electronic display device, the user may insert the reversible ink-stylus assembly into the cartridge holder ink tip first, such that the stylus tip protrudes from an orifice of writing device 100. In an example, if the user hears one “click,” this may indicate to the user that the reversible ink-stylus assembly has been properly inserted into the cartridge holder. Accordingly, the user may commence writing on the electronic display device with writing device 100, using the stylus tip.

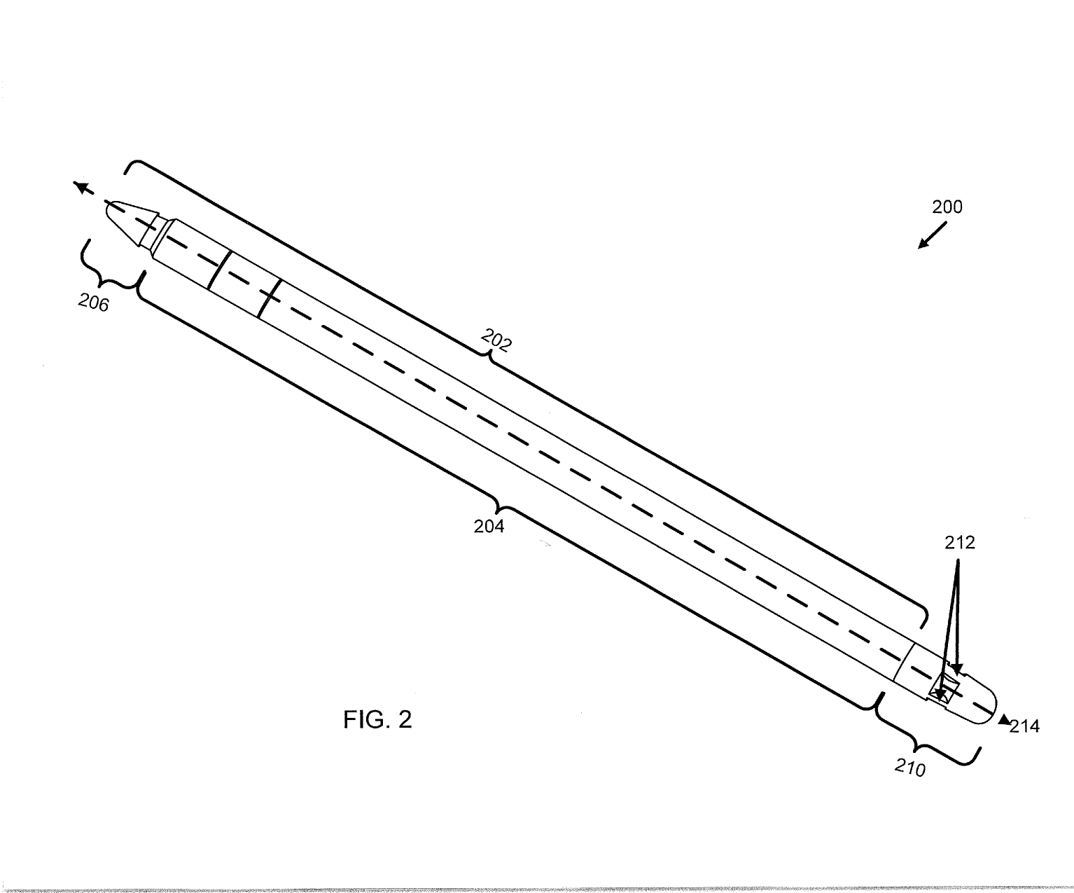

FIG. 2 is a diagram illustrating a reversible ink-stylus assembly 200, consistent with some embodiments. Reversible ink-stylus assembly 200 includes an ink cartridge assembly 202 that includes an ink cartridge 204 and an ink tip 206. Ink tip 206 is attached to a first end of ink cartridge assembly 202. A stylus tip 210 has a plurality of ribs 212 along a longitudinal axis 214 of reversible ink-stylus assembly 200. Stylus tip 210 is attached to a second end of ink cartridge assembly 202. Ink cartridge assembly 202 is insertable into a longitudinal cylindrical opening of writing device 100.

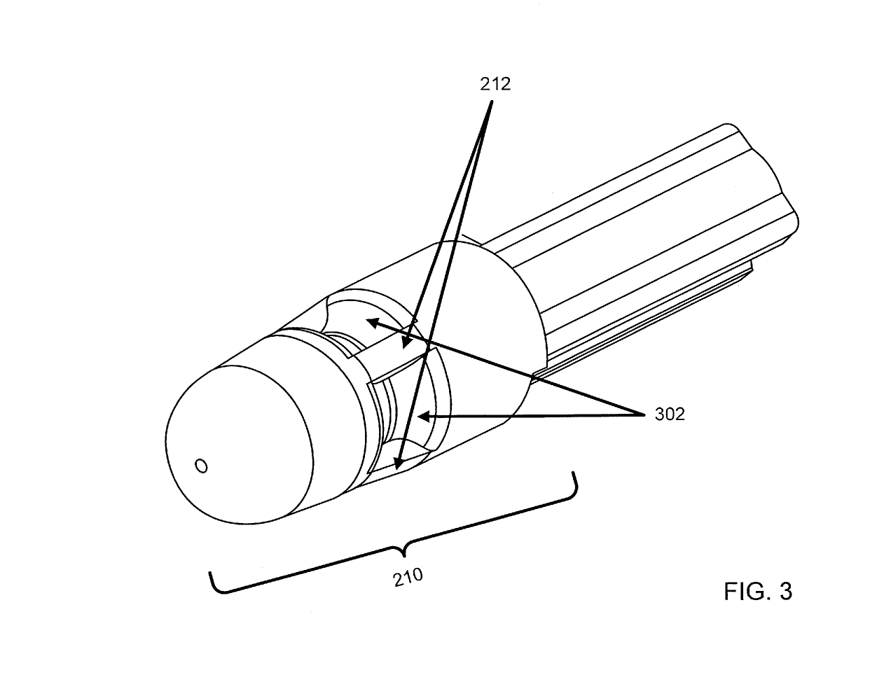

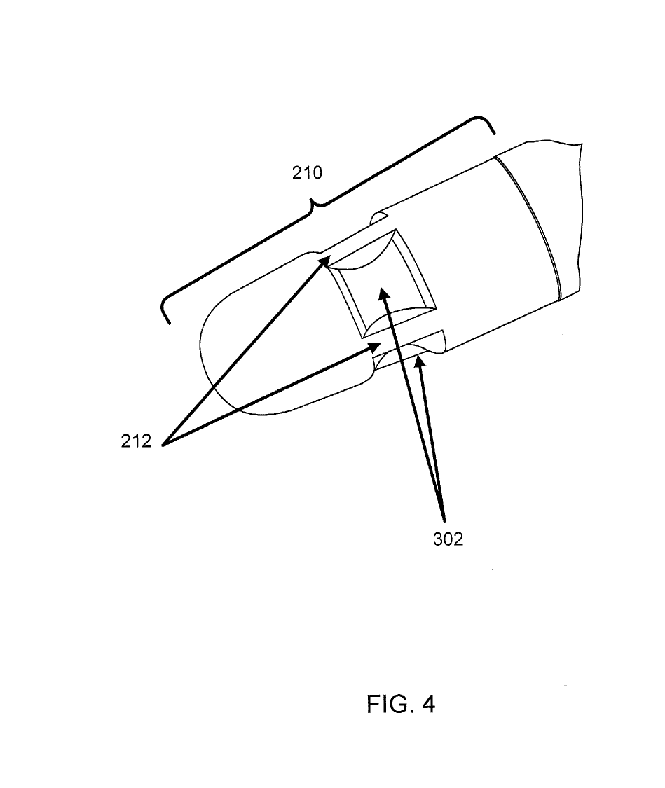

FIG. 3 shows a closer view of stylus tip 210 of the reversible ink-stylus assembly, consistent with some embodiments. FIG. 4 is another view of stylus tip 210, consistent with some embodiments. In FIGS. 3 and 4, stylus tip 210 has plurality of ribs 212 in the fingernail-groove section and a plurality of grooves 302. In some examples, stylus tip 210 has four ribs that are separated by 90 degrees. Plurality of ribs 212 may allow for a smooth transition into the cartridge holder in writing device 100. For example, plurality of ribs 212 creates a ramp feature and allows for a gradual transition into writing device 100 so that a user may hear one click rather than two clicks when the cartridge holder attaches to plurality of ribs 212 and plurality of grooves 302.

Additionally, plurality of ribs 212 eases the concern of reversible ink-stylus assembly 200 falling out of writing device 100. The cartridge holder securely retains the reversible ink-stylus assembly to accept the user inputs for force sensing. The stylus tip securely slides and snaps into cartridge holder and remains in writing device 100 until the user reverses the reversible ink-stylus assembly.

Further, plurality of grooves 302 may allow the user to more easily extract reversible ink-stylus assembly 200 from writing device 100. For example, the user may pinch onto the grooves and pull out reversible ink-stylus assembly 200 with her fingernails. The grooves should not be too shallow such that the user has difficulty gripping onto the grooves. Rather, the grooves should be steep enough so that the user may easily grip onto the grooves, but not too steep that not enough material is present to prevent the stylus tip from breaking or from flexing too much when the user writes with the stylus tip.

In some examples, the cartridge holder “clicks” onto reversible ink-stylus assembly 200. The presence of plurality of ribs 212 on reversible ink-stylus assembly may avoid the need to wait for a “double click” for the reversible ink-stylus assembly to be properly seated into the cartridge holder, and allow a smooth transition from a smaller diameter to the nominal diameter of the stylus tip. This gradual transition allows the stylus tip to be more easily inserted into the cartridge holder, thus yielding a single click for the user. If a user were to insert an ink cartridge assembly having stylus tip 210, the user may insert the ink tip or stylus tip end into writing device 100 and sense a single click, knowing that the ink cartridge assembly is seated properly in the product regardless of which tip the user is using to write.

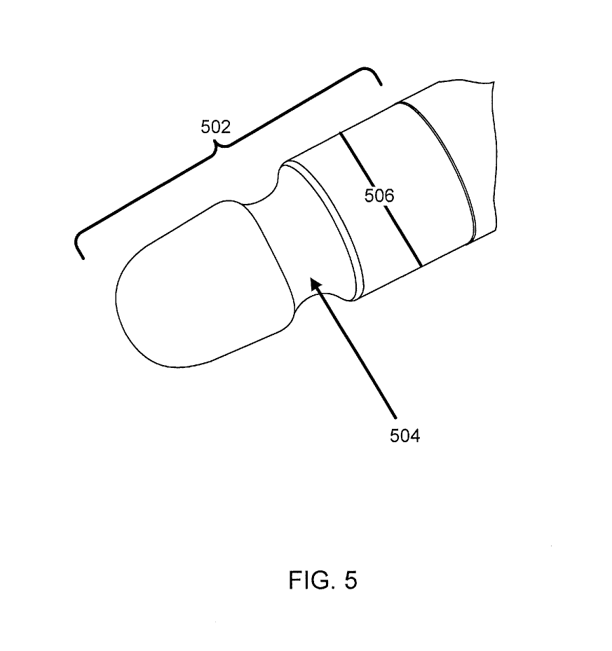

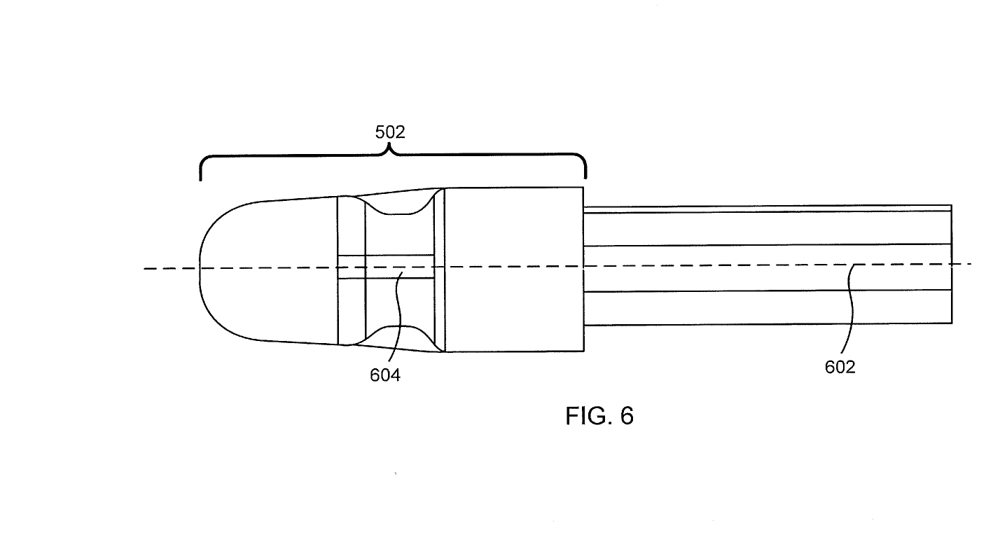

Plurality of ribs 212 may be formed on the fingernail-groove section of the stylus tip by using an injection molding process. FIGS. 5 and 6 provide example diagrams illustrating the production of stylus tip 210 having plurality of ribs 212. FIG. 5 is a diagram illustrating stylus tip 502 having a fingernail-groove section 504, consistent with some embodiments. Fingernail-groove section 504 does not have ribs. Stylus tip 502 may be attached to an end of an ink cartridge assembly. In FIG. 5, fingernail-groove section 504 may be uniform and extend along a circumference of stylus tip 502. A diameter 506 of stylus tip 502 may be, for example, approximately or exactly 2.3 millimeters. A diameter of fingernail-groove section 504 is smaller than diameter 506. Additionally, plurality of ribs 212 may extend above the fingernail-groove section. A user may user her fingernails to grasp onto fingernail-groove section 504 to easily insert and extract reversible ink-stylus assembly from writing device 100.

FIG. 6 is a diagram illustrating the formation of plurality of ribs 212 on fingernail-groove section 504. In some examples, two metal cavities may join together, and a parting line 602 partitions a rib 604 in half. Parting line 602 runs down the middle of rib 604 and splits one of plurality of ribs 212, such that two halves of rib 604 are produced. Parting line 602 may represent the middle of rib 604 along with the middle of the rib that is 180 degrees from rib 604 along the groove.

An injection molding tool may have two halves allowing for one parting line, or may have multiple parting lines. Each half of the injection molding tool may have a negative of the geometry so that when the two metal cavities join together and are heated up, material that is pushed through the injection molding tool fills some portions of fingernail-groove section 504 to create the depth of plurality of ribs 212. The injection molding tool may create two symmetric halves that mirror each other in terms of shape, size, and location of the ribs. The spacing between adjacent ribs of plurality of ribs 212 may be the same across all ribs. In some examples, the material is a polycarbonate-ABS thermoplastic. In an example, the material is ester polyurethane. To ease the separation of the injection molding tool from plurality of ribs 212, plurality of ribs 212 may be slightly angled downward toward the end of the stylus tip. In some examples, each rib of plurality of ribs 212 has 1-3 degrees of draft, thus creating a taper.

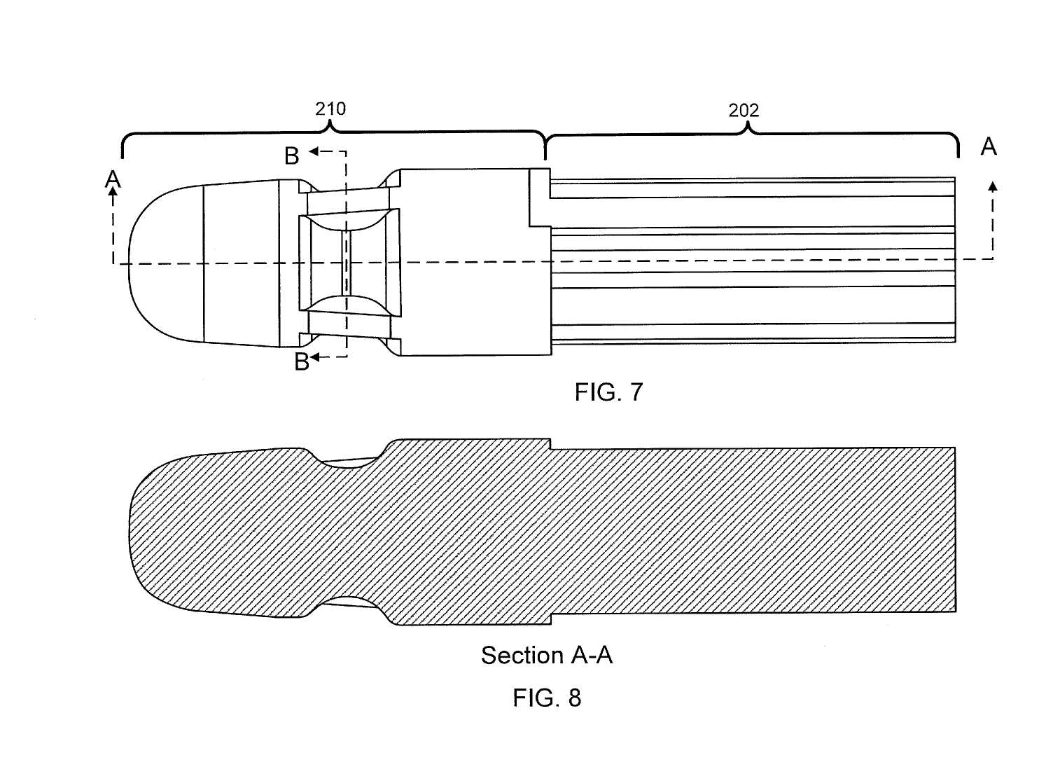

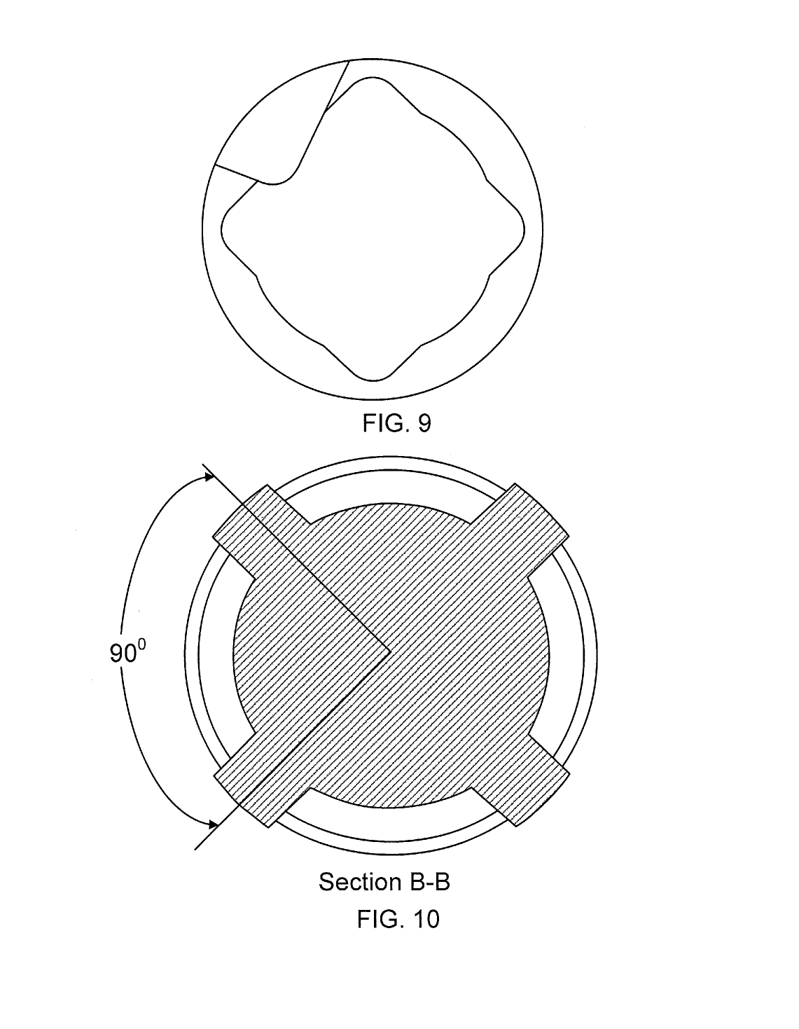

FIG. 7 is a view of stylus tip 210 attached to an end of ink cartridge assembly 202, consistent with some embodiments. Stylus tip 210 has a plurality of ribs and plurality of grooves. FIG. 8 shows a section view taken along cross section A-A shown in FIG. 7, consistent with some embodiments. FIG. 9 shows a top cross section view of ink cartridge assembly 202 shown in FIG. 7, consistent with some embodiments. FIG. 10 shows a radial view taken along cross section B-B shown in FIG. 7, consistent with some embodiments. As can be seen in FIG. 10, the ribs are spaced 90 degrees apart from each other. This is not intended to be limiting, and the space between adjacent ribs may be greater or less than 90 degrees. The degree in which ribs may be spaced apart may depend on factors such as how many ribs the stylus tip has, the circumference of the fingernail-groove section, etc.

Although the stylus has been described with respect to an ultrasound pen, other advantages are apparent in still other alternative embodiments where the reversible ink-stylus assembly is used in combination with a smartpen, which in common forms may include a microphone to record audio, a speaker for playback, a display, and or an internal memory for capturing handwritten notes, audio, and drawings.

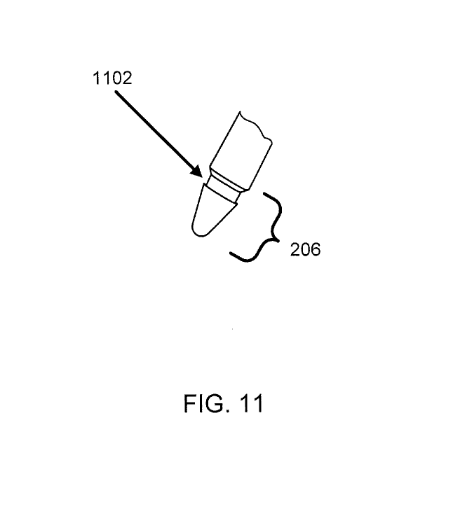

Additionally, although the stylus tip is described above as including a plurality of ribs and a plurality of grooves, it should be understood that this description applies as well to the ink tip. In an example, the ink tip may include a second fingernail-groove section, and a second plurality of ribs extends above the second fingernail-groove section. For example, FIG. 11 shows a closer view of the ink tip 206 of the reversible ink-stylus assembly having a finger-nail groove section 1102, consistent with some embodiments. Using the techniques discussed in the present disclosure, a plurality of ribs may extend above fingernail-groove section 1102.

In some embodiments, writing device 100 has a plurality of ribs on the ink tip as well as on the stylus tip. In some embodiments, writing device 100 has a plurality of ribs on the stylus tip, but not on the ink tip. In some embodiments, writing device 100 has a plurality of ribs on the ink tip, but not on the stylus tip.

As discussed above and further emphasized here, FIGS. 1-10 are merely examples that should not unduly limit the scope of the claims. One skilled in the art may readily devise other systems or writing devices consistent with the disclosed embodiments which are intended to be within the scope of the present disclosure. The foregoing disclosure is not intended to limit the present disclosure to the precise forms or particular fields of use disclosed. As such, it is contemplated that various alternate embodiments and/or modifications to the present disclosure, whether explicitly described or implied herein, are possible in light of the disclosure. Changes may be made in form and detail without departing from the scope of the present disclosure. Thus, the present disclosure is limited only by the claims.

What is claimed is:

1. A reversible ink-stylus assembly, comprising:
an ink cartridge assembly including an ink cartridge and an ink tip, wherein the ink tip is attached to a first end of the ink cartridge; and
a stylus tip having a plurality of ribs along a longitudinal axis of the reversible ink-stylus assembly,
wherein the stylus tip is attached to a second end of the ink cartridge, and wherein the ink cartridge assembly is insertable into a longitudinal cylindrical opening of a writing device.

2. The reversible ink-stylus assembly of claim 1, wherein the writing device includes a cartridge holder that attaches to the reversible ink-stylus assembly.

3. The reversible ink-stylus assembly of claim 1, wherein the stylus tip has four ribs.

4. The reversible ink-stylus assembly of claim 3, wherein each of the four ribs is separated by 90 degrees.

5. The reversible ink-stylus assembly of claim 1, wherein the writing device produces a common event when the stylus tip is inserted into the writing device and when the ink tip is inserted into the writing device.

6. The reversible ink-stylus assembly of claim 1, wherein the stylus tip includes a fingernail-groove section.

7. The reversible ink-stylus assembly of claim 6, wherein the fingernail-groove section extends along a circumference of the stylus tip.

8. The reversible ink-stylus assembly of claim 6, wherein the plurality of ribs extends above the fingernail-groove section.

9. The reversible ink-stylus assembly of claim 6, wherein the ink tip includes a second fingernail-groove section.

10. The reversible ink-stylus assembly of claim 9, wherein a second plurality of ribs extends above the second fingernail-groove section.

11. A writing device, comprising:
a reversible ink-stylus assembly that includes:
an ink cartridge assembly including an ink cartridge and an ink tip, wherein the ink tip is attached to a first end of the ink cartridge; and
a stylus tip having a plurality of ribs along a longitudinal axis of the reversible ink-stylus assembly, wherein the stylus tip is attached to a second end of the ink cartridge; and
a cartridge holder located inside the writing device, wherein the cartridge holder attaches to the plurality of ribs of the stylus tip to secure the reversible ink-stylus assembly into the cartridge holder.

12. The writing device of claim 11, wherein the stylus tip has four ribs.

13. The writing device of claim 12, wherein each of the four ribs is separated by 90 degrees.

14. The writing device of claim 11, wherein the writing device produces a common event when the stylus tip is inserted into the writing device and when the ink tip is inserted into the writing device.

15. The writing device of claim 11, wherein the stylus tip includes a fingernail-groove section.

16. The writing device of claim 15, wherein the fingernail-groove section extends along a circumference of the stylus tip.

17. The writing device of claim 15, wherein the plurality of ribs extends above the fingernail-groove section.

18. The writing device of claim 15, wherein the ink tip includes a second fingernail-groove section.

19. The writing device of claim 15, wherein a second plurality of ribs extends above the second fingernail-groove section.

20. The writing device of claim 11, wherein spacing between adjacent ribs of the plurality of ribs are the same.
